(19) United States
(12) Patent Application Publication
(10) Pub. No.: US 2016/0024823 A1
(43) Pub. Date: Jan. 28, 2016

(54) Door Handle and Power Configuration

(71) Applicant: Joel David McAndrew, Brisbane (AU)

(72) Inventor: Joel David McAndrew, Brisbane (AU)

(21) Appl. No.: 14/706,958

(22) Filed: May 7, 2015

(30) Foreign Application Priority Data
Jul. 22, 2014 (AU) 2014204557

(51) Int. Cl. E05C 1/16; H04W 4/00; G07C 9/00; G05B 15/02

(52) U.S. Cl. CPC E05C 1/16; G05B 15/02; H04W 4/008; G07C 9/00182

(57) ABSTRACT

The present invention provides a lock and handle assembly for a door comprising a latch moveable between an extended position in which the door is prevented from opening, and a release position allowing opening of the door; a lock having a locked state in which the latch is retained in the extended position, and an unlocked state allowing movement of the latch to the release position; a receiver to receive control instructions via a wireless communication medium, to change the lock between the locked state and the unlocked state; and a handle operable by a user to move the latch between the extended position and the release position, when the lock is in the unlocked state, thereby allowing the user to open the door. A power configuration and wireless communication system for such a lock (and other home automation devices) is also provided.

### FIELD OF THE INVENTION

The present invention relates generally to wirelessly controlled appliances. It has particular relevance to wireless control of electronic door locking systems, and will henceforth be described with particular reference to such systems. However, the invention may have broader application to other wireless appliances and home automation devices.

### BACKGROUND OF THE INVENTION

Home automation is increasing, with home automation systems allowing remote control of a wide range of electronic devices. These can include lights, heating and cooling systems, garage doors, and other appliances and other devices around the home. Control over these devices can be through internal home wired networks, but wireless control is often preferable. In some cases, these devices may also be connected to the Internet, in order to increase the ability for users to remotely control their function, regardless of the location of the user.

One type of home automation device is an electronic door lock or ‘smart lock’. However, these types of locks have a number of challenges. The first challenge for an electronic lock is to provide security, so that the lock can appropriately restrict access through the door. However, simple operation of the lock (for authorised persons) is also an aim—all home automation devices are intended to provide convenience for their users. Furthermore, ensuring a constant power supply to these locks can be important, and can be a challenge for door locks which may not be connected to mains power. Finally, it is desirable for these locks to be aesthetically pleasing.

There is a need for improved locking systems which address one or more of the above challenges, or at least provide a commercial alternative to current electronic locking systems.

### SUMMARY OF THE INVENTION

According to an aspect of the present invention, there is provided a lock and handle assembly for a door comprising:

a latch moveable between an extended position in which the door is prevented from opening, and a release position allowing opening of the door;

a lock having a locked state in which the latch is retained in the extended position, and an unlocked state allowing movement of the latch to the release position;

a receiver to receive control instructions via a wireless communication medium, to change the lock between the locked state and the unlocked state; and

a handle operable by a user to move the latch between the extended position and the release position, when the lock is in the unlocked state, thereby allowing the user to open the door.

In the context of this specification, a “wireless communication medium” is used to refer to any technology or communication standard which enables wireless communication between electronic devices.

Prior ‘smart locks’ have only been provided in a deadlock form. As such, they either have no latch holding the door closed (when the lock is in the unlocked state), or they require an additional latch associated with a user-operated handle. The use of a handle and lock that control a single latch means that fewer components may be required in the door, and may also provide a more traditional feel to the operation of the door.

In a second aspect of the invention, there is provided a control system for an appliance comprising:

a local controller comprising a first receiver to receive control instructions via a first wireless communication medium, wherein the controller is configured to adjust a function of the appliance upon receiving the control instructions; and

a hub comprising a second receiver configured to receive control instructions via a second wireless communication medium, and comprising a transmitter to transmit the control instructions to the first receiver using the first wireless communication medium.

The local controller may be powered by a local power source, such as a battery, whereas the hub may be controlled using a mains power source. In such an embodiment, the first wireless communication medium (such as Bluetooth) may have lower power requirements than the second wireless communication medium (such as Wi-Fi). In this way, the appliance can still be controlled using the higher power consumption technology (e.g. Wi-Fi). However, the battery life of the local controller is prolonged, because it receives signals using the lower power consumption technology. This means the user does not need to replace the local controller batteries as frequently.

The control system may further include a remote control device having a second transmitter to transmit control instructions to the second receiver using the second wireless communication medium. The remote control device may be a mobile phone or other mobile communications device, such as a tablet, which can be associated with a particular (authorised) person.

In a further aspect of the present invention, there is provided a method of controlling an appliance comprising:

receiving control instructions at a hub, via a first wireless communication medium;

transmitting the control instructions to a local controller for controlling the appliance, via a second wireless communication medium.

According to a further aspect of the present invention, there is provided a computer-implemented system for controlling an appliance, said system comprising one or more computers including:

(a) at least one processor;

(b) at least one storage medium operatively coupled to said processor, said storage medium containing program instructions for execution by said processor, said program instructions causing said processor to execute the steps of the method of the above method, or any of the computer-implemented methods described herein.

According to a still further aspect of the present invention, there is provided a tangible computer-readable medium having computer-executable instructions stored thereon for directing a programmable device to perform the above method, or any of the computer-implemented methods described herein.

A detailed description of one or more embodiments of the invention is provided below, along with accompanying figures that illustrate by way of example the principles of the invention. While the invention is described in connection with such embodiments, it should be understood that the invention is not limited to any embodiment. On the contrary, the invention encompasses numerous alternatives, modifications and equivalents.

For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF DRAWINGS

FIG. 1 depicts a door handle assembly in accordance with a representative embodiment of the present invention;

FIG. 2 depicts the door handle assembly of FIG. 1, with a key mechanism for operating the lock exposed;

FIG. 3 depicts the door handle assembly of FIG. 1, in operation to open the door; and

FIG. 4 is a schematic block diagram of the communication interfaces between the components of a door handle assembly according to a representative embodiment of the present invention.

### DETAILED DESCRIPTION

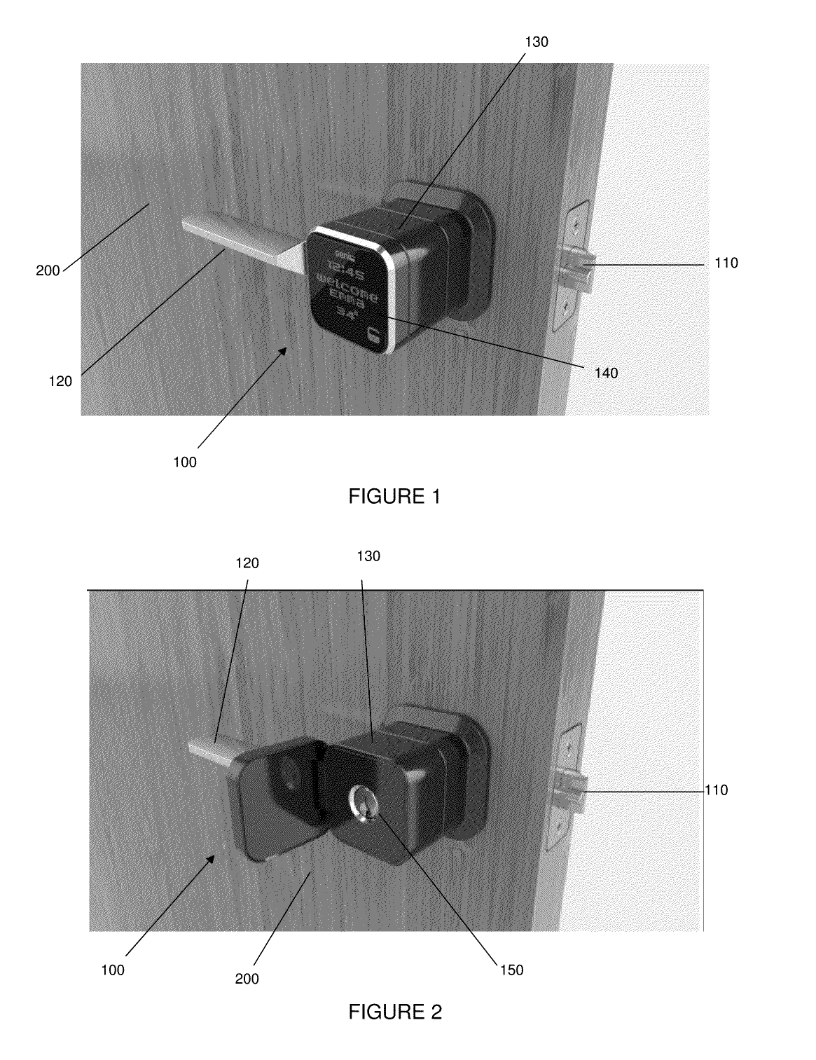

Referring to FIG. 1, there is depicted an exemplary door handle assembly 100 according to a representative embodiment of the present invention. The assembly 100 is mounted on a door 200, and at a high level comprises a latch 110, a handle 120, a lock 130, and an electronic display 140. The lock 130 includes a wireless receiver, to enable the door 200 to be locked or unlocked using an electronic device.

Referring to the latch 110, this component is of a known type having an extended state (shown in FIG. 1) wherein, when the door 200 is closed, the latch 110 engages a corresponding formation on the door frame to prevent the door from being opened. The latch 110 is retracted in order to open the door 200.

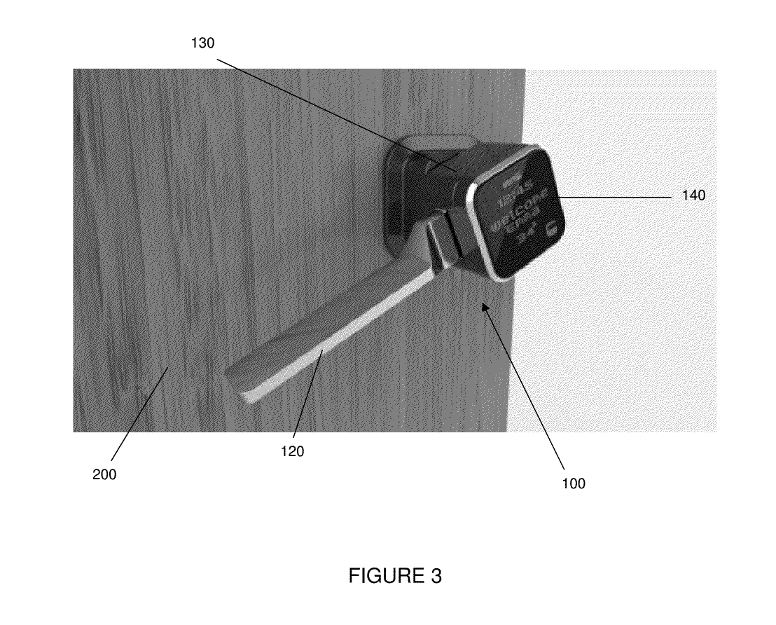

A door handle 120 is operably connected to the latch 110, and operation of the door handle 120 is depicted in FIG. 3. In this embodiment, the door handle 120 is a lever-type handle; however, many other types of door handle 120 are known (for example rotatable door knobs), and could be used to move the latch 110 to its retracted or ‘release’ position. Once the latch 110 is retracted, the door 200 can be opened.

A lock 130 is provided to selectively permit or prevent opening of the door 200. When the lock 130 is in a locked state, the handle 120 cannot be operated to retract the latch 110. This may be accomplished by restricting movement of both the handle 120 and latch 110. However, in some embodiments, the door may be locked by disengaging the handle 120 from the latch 110, such that operation of the handle 120 no longer retracts the latch 110.

The lock 130 is electronically operated, in that it includes a receiver to receive electronic control instructions to lock or unlock the door 200. The control instructions are preferably provided over a wireless communication medium—and a number of wireless communication media could be used. By way of (non-exhaustive) example, Bluetooth, Infrared, Wi-Fi or Near Field Communication technologies could be used in accordance with different embodiments of the present invention.

The lock may be controlled using a remote control device 300, such as a mobile phone associated with a particular authorised person. The mobile phone 300 may have software installed (e.g. an app) which enables the user to monitor the status of the lock 130 (e.g. locked, unlocked). Furthermore, the mobile phone 300 may automatically interact with the lock 130, by Bluetooth or Wi-Fi connection, whenever it comes within a certain proximity. Accordingly, whenever the authorised person approaches the door 200, the door 200 may be automatically unlocked without requiring the person to take any action or manually input control instructions into their mobile phone 300—the control instructions may be generated and transmitted automatically to the lock 130. However, embodiments allowing the user to manually enter control instructions may be provided—for instance, depending on security requirements, a user may be able to unlock the door 200 from a remote location, by pressing a button on an app on their mobile phone 300. This may be used, for example, to allow the user to provide access to a third party at a time when the user cannot be present themselves.

Users could be designated as authorised users by assigning them an electronic token, which could be imported to their mobile phone. Alternatively, different types of remote control devices could be used. For the purposes of the present specification, for example, a key fob is considered to be a remote control device, in that it can be used to control the locking or unlocking of lock 130 and thereby provide access through the door 200. An authorised user could be assigned a key fob having a code enabling operation of the lock.

The assembly 100 may include an electronic display 140. The display 140 may be configured to display a variety of types of information—for example, it may display information embedded or recognised from the control instructions, such as the name of the person associated with a nearby remote control device (mobile phone) 300. In some cases, it may be appropriate to display status information, such as whether the lock 130 is locked or unlocked. Alternatively, the display 140 may display current events such as the temperature or a recent news headline that may be of interest. The information provided on display 140 may be customised for and by each authorised user, using an app on their mobile phone 300. Although a visual display 140 is depicted in the figures, other output devices may also be used—for example, an audio speaker may be provided to emit an electronic beep when the lock changes between its locked and unlocked states.

The use of a lock 130 which can be locked or unlocked by wireless communication, and having an electronic display 140, requires power. However, because the lock 130 is mounted in the door 200, it can be difficult or impossible to connect it to a mains power supply. Therefore, the lock 130 in accordance with this embodiment of the present invention is battery powered.

If the battery runs out, it will still be necessary to operate the lock in order to open the door. Accordingly, manual unlocking means may be provided, such as a keyhole to receive a key, as shown in FIG. 2.

Furthermore, power consumption of the door handle assembly 100 is important, particularly if it is battery powered. Accordingly, to prolong battery life, a low energy wireless communication medium is preferred (e.g. Bluetooth). However, there are also advantages to using a high energy communication protocol, such that it will allow wider access to the door handle and lock assembly 100—for instances, users can operate the lock from further away, or over different networks and using more powerful devices.

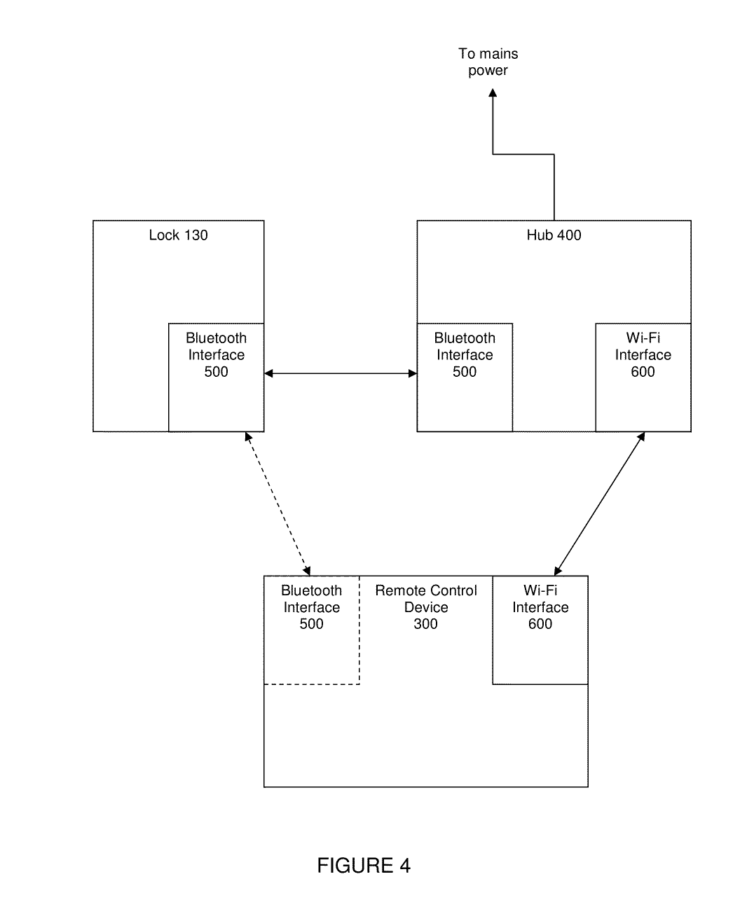

Accordingly, the present invention provides a control system for the lock (applicable to other devices) which includes a hub 400 which can be connected to mains power, as shown in FIG. 4. Furthermore, the hub 400 may be positioned sufficiently near the door 200 that it can interact with the lock 130 using a low energy wireless communication medium. As shown in FIG. 4, a Bluetooth interface 500 is provided enabling communication between the hub 400 and the lock 130. However, the hub 400 may also be equipped to communicate using other wireless communication technologies, such as Wi-Fi, and so a Wi-Fi interface 600 may be provided.

In this control configuration, the lock may be operated as follows. A mobile phone 300 belonging to an authorised user may approach within a predetermined distance of the hub. The mobile phone 300 includes a wireless transmitter which can transmit control instructions using a Wi-Fi standard to a wireless receiver at the hub 400. The hub 400 includes a wireless transmitter configured to transmit the control instructions to the lock 130 using the Bluetooth (low energy) standard, which unlock the lock 130 and allow the user to open the door using handle 120.

Of course, the Bluetooth interface 400 and Wi-Fi interface 600 may also enable communication in the reverse direction—status information, for example, can be transmitted from a transmitter of lock 130, to the user's mobile phone 300 via hub 400. The user could then monitor the status of the lock 130 on their mobile phone 300. This may include locked or unlocked state, and may also include battery levels. A notification may be automatically generated when the lock 130 is running low on battery power.

Although this power and control configuration has been described with particular reference to an electronic lock, it may be applied to different types of home automation appliances. Furthermore, although the communication has been described with particular reference to Bluetooth and Wi-Fi standards, different communication standards may also be used—both currently known standards and new standards that may be defined in the future.

It should be appreciated that the hardware used to implement the method of the invention may be conventional in nature or specifically designed for the purpose.

As the present invention may be embodied in several forms without departing from the essential characteristics of the invention, it should be understood that the above described embodiments should not be considered to limit the present invention but rather should be construed broadly. Various modifications, improvements and equivalent arrangements will be readily apparent to those skilled in the art, and are intended to be included within the spirit and scope of the invention.

The word ‘comprising’, and forms of the word ‘comprising’, when used in this specification is taken to specify the presence of stated features, integers, steps or components but does not preclude the presence or addition of one or more other features, integers, steps, components or groups thereof.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

The claims defining the invention are as follows:

1. A lock and handle assembly for a door comprising:
a latch moveable between an extended position in which the door is prevented from opening, and a release position allowing the door to be opened;
a lock having a locked state in which the latch is retained in the extended position, and an unlocked state allowing movement of the latch to the release position;
a receiver to receive control instructions using a wireless communication medium, to cause the lock to change between the locked state and the unlocked state; and
a handle operable by a user to move the latch between the extended position and the release position, when the lock is in the unlocked state, thereby allowing the user to open the door.

2. An assembly as claimed in claim 1, wherein the wireless communication medium is Bluetooth.

3. An assembly as claimed in claim 1, wherein the wireless communication medium is Wi-Fi.

4. An assembly as claimed in claim 1, further comprising a display configured to display information based on the control instructions.

5. An assembly as claimed in claim 1, wherein the lock is configured to change to the locked state after a certain time since becoming unlocked.

6. An assembly as claimed in claim 1, wherein the handle is of a lever type to operate the latch.

7. An assembly as claimed in claim 1, further comprising a mechanical mechanism to cause the lock to change to its unlocked state.

8. A control system for a door, comprising:
an assembly as claimed in any one of claims 1 to 7; and
a remote control device comprising a wireless transmitter, and configured to transmit the control instructions.

9. A control system as claimed in claim 8, further comprising a hub, the hub having a hub receiver to receive the control instructions, and a transmitter to transmit the control instructions to the receiver of the lock and handle assembly.

10. The control system of claim 9, wherein the hub is connected to mains power and the assembly is battery powered.

11. A control system for an appliance comprising:
a local controller comprising a first receiver to receive control instructions using a first wireless communication medium, wherein the controller is configured to adjust a function of the appliance upon receiving the control instructions; and
a hub comprising a second receiver configured to receive control instructions using a second wireless communication medium, and comprising a transmitter to transmit the control instructions to the first receiver using the first wireless communication medium.

12. The control system of claim 11, wherein the first wireless communication medium is a low energy wireless communication medium.

13. The control system of claim 11 or 12, wherein the second wireless communication medium is a higher energy wireless communication medium than the first wireless communication medium.

14. The control system of any one of claims 11 to 13, wherein the first wireless communication medium is Bluetooth.

15. The control system of any one of claims 11 to 14, wherein the second wireless communication medium is Wi-Fi.

16. The control system of any one of claims 11 to 15, wherein the hub is connected to a mains power supply and the local controller is battery powered.

17. The control system of any one of claims 11 to 16, wherein the appliance is a lock for a door, and the local controller is configured to cause the lock to change between a locked state and an unlocked state.
